(19) United States
(12) Patent Application Publication
(10) Pub. No.: US 2006/0243693 A1
(43) Pub. Date: Nov. 2, 2006

(54) Multifunctional mobile platform for contactless load inspection and for transporting containers

(76) Inventors: Otto Weis, Oberpleichfeld (DE); Klaus-Peter Franke, Dettelbach (DE)

Correspondence Address: WILLIAM COLLARD;COLLARD & ROE, P.C., 1077 NORTHERN BOULEVARD, ROSLYN, NY, 11576, US

(21) Appl. No.: 10/550,135

(22) PCT Filed: Jan. 10, 2004
(86) PCT No.: PCT/DE04/00017

§ 371 Date: Oct. 26, 2005

(30) Foreign Application Priority Data
Mar. 25, 2003 (DE) 103 13 248.1
Mar. 25, 2003 (DE) 203 09 047.0

(51) Int. Cl. B66D 3/18

(52) U.S. Cl. 212/271

(57) ABSTRACT

The invention relates to a mobile multifunctional platform for the transport and contact-free load inspection of containers, preferably of containers that are loaded using container bridges, having a
crane device for changing the position of containers (6),
platform (7, 35) for containers (6),
transillumination device (12, 14, 15),
shielding (16, 33), and
displacement possibility (9) on the mobile platform (7, 35).

The invention can be used anywhere where it is necessary to perform contact-free load inspection of containers (6), and container bridges (3) cannot be retrofitted with transillumination devices (Figure).

The invention relates to a mobile multifunctional platform for the transport and contact-free load inspection of containers, in accordance with the preamble of the first claim.

The platform is suitable for the transport and contact-free load inspection control of containers, preferably of containers that are loaded and unloaded using container cranes. This is particularly the case in harbors in which containers are loaded into and unloaded from ships. The mobile multifunctional platform can also be used in other locations where containers are trans-shipped, for example in trans-shipping locations where containers are unloaded from railcars onto trucks, transported, and inspected, or also at airports from which containers are transported. The platform is also suitable in connection with devices for the installation and removal of semi-automatic twistlocks, such as those described in EP 0 699 164 B1.

Devices for transilluminating piece goods are known and generally function on the basis of X-rays or gamma rays. They are used to transilluminate the luggage of passengers in suitable manner, and to determine whether or not hazardous objects are present in the transport container.

Transillumination procedures and devices for transilluminating larger transport receptacles such as containers are also known. These are larger units from which radiation is sent through a container or a transport receptacle, in order to check whether or not objects and devices for which transport is not planned are located in the container. This is particularly the case at locations where containers or larger transport receptacles are part of border-crossing traffic, particularly containers that are being transported to other countries on trucks, planes or ships. A problem with such devices, which are located on the ground, is that a transport means with the container must pass through the device, and this requires that a corresponding shield must be present for the driver or persons located in the vicinity. In particular, a separate reloading or transport process is required, in order to be able to transilluminate a corresponding container. Such methods cannot be used, in particular, if a large number of containers is supposed to be loaded and unloaded quickly, since a long standing time for containers or a long docking time for ships in harbors is disadvantageous.

A device is known from U.S. Pat. No. 5,638,420, with which containers are transilluminated from above, in that a vehicle having a cabin passes over the container and performs the transillumination.

A device for checking the content of closed load carriers, particularly containers, is evident from DE 198 26 560 A1, using X-rays; this device is used to transilluminate the container from the side, by means of a transillumination device disposed on a vehicle. Both devices have the disadvantage that only a single container can be transilluminated, and only after it has been set down by the crane, and that a special device that must pass over the container is required for this.

Further developments, such as those that were presented in “A Revolution in Security Inspection Technology,” Dr. Franke, Conference, Rotterdam, Feb. 11, 2003, provide for disposing transillumination devices on the crane system or on a platform on the crane system, in such a manner that containers pass through these facilities, and in this manner, transillumination of the piece goods to be transported takes place. A disadvantage of this system, however, is that existing crane systems cannot be retrofitted with this equipment in every case, since the original crane construction is designed only for very specific loads.

It is therefore the task of the invention to develop a device with which contact-free load inspection of containers is possible, without the occurrence of the stated disadvantages of the state of the art.

This task is accomplished by means of a device according to the characteristics of the first claim.

Dependent claims reproduce advantageous embodiments of the invention.

The solution according to the invention provides for a self-propelled mobile multifunctional platform for the transport and transillumination of containers, which is characterized in that a crane device for lifting the containers, a set-down possibility for containers, as well as a transillumination device with shielding are present on it, whereby the mobile platform has a displacement possibility. Street driving wheels, for example with rubber tires, but also rail-guided wheels can be disposed as the displacement possibility.

A pivot crane can be used as the crane device of the mobile platform, to which crane spreaders are attached, whereby the pivot arms are pivoted by way of hydraulic cylinders, in such a way that the containers can be set down on the platform and removed from it and set down next to the platform.

However, instead of the pivot crane, it is also possible to dispose a portal crane on the platform, which lifts the containers onto the platform and sets them down onto the set-down possibility of the platform.

It is advantageous if the mobile platform has supports, so that it can be used to pass over containers. In order to make lifting of the containers by means of a portal crane possible, it is advantageous in the mobile platform has an opening for passing containers through.

The self-propelled platform is equipped with appropriate wheel sets, depending on the loads.

In addition to wheels for displacement, the mobile platform can be supported with set-down plates, with which a stable position is achieved at any time.

Since it is advantageous to use the mobile platform to transilluminate containers that are transported using container crane systems, the working height of the platform must be less than the height of the crossbeam of the container bridge under which it must pass. In order to be able to pass over container transport vehicles with their containers, the clear height below the platform must be greater than the container vehicles over which it must pass. It is furthermore advantageous to dispose a conveyor belt on the platform, for horizontal transport of the containers.

Furthermore, it is advantageous to dispose collision monitoring devices on the mobile platform.

It is furthermore advantageous to couple the container bridge and the platform with one another in terms of control technology. The function of the platform is provided in such a manner that containers that are being unloaded from ships by means of a container crane, for example, and must be transilluminated, are set down onto the platform by the container crane, at the set-down position for containers, and in this set-down position, the transillumination device passes over them and transilluminates them on the platform. If the content of a container is unproblematic, the container is picked up by the crane device of the platform, and passed on for further transport. If the container must be sorted out due to possible problems, it is set down at a suitable location by the crane device and the transport device, in order to check the contents, or the non-released container is transported back onto the container ship. In the same manner, containers can also be transported from the pier to the container ship, by way of the platform/transillumination.

In the following, the invention will be explained in greater detail using an exemplary embodiment and seven figures. The figures show:

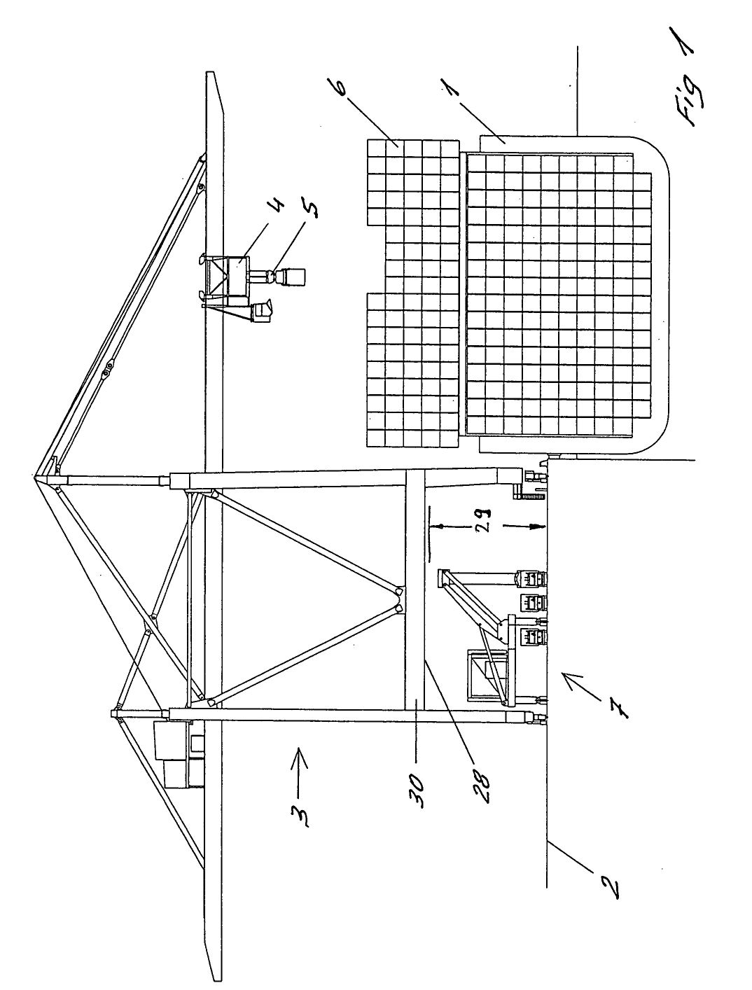

FIG. 1: Container crane unloading a ship, under which the mobile multifunctional platform is disposed.

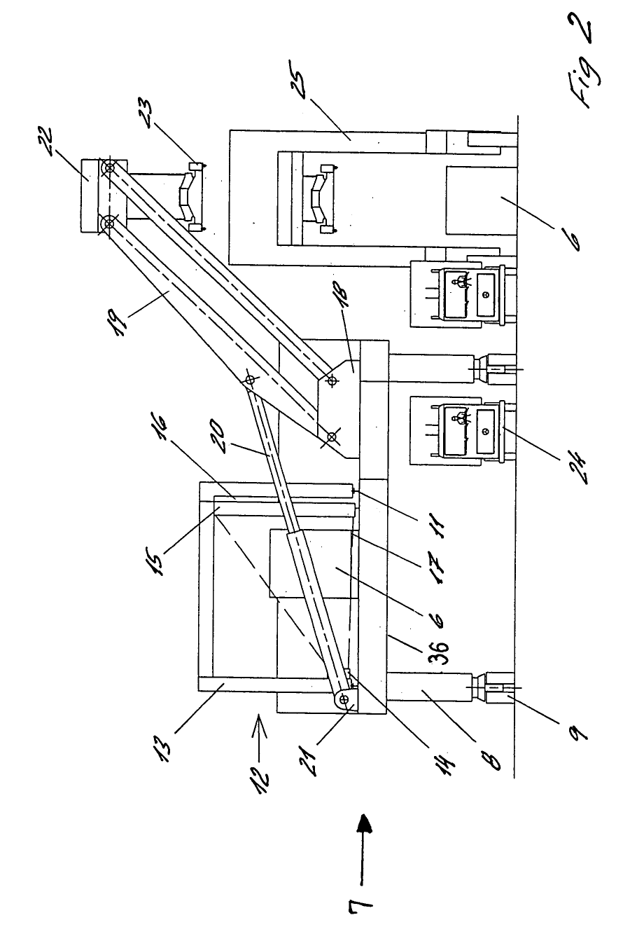

FIG. 2: Multifunctional platform with pivot crane in a side view.

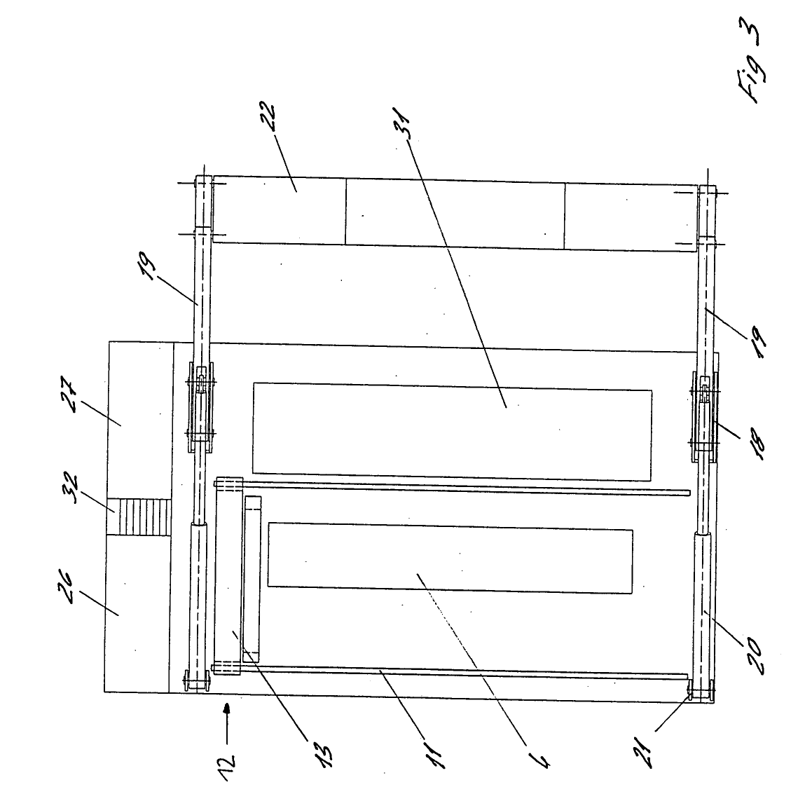

FIG. 3: Multifunctional platform with pivot crane in a top view.

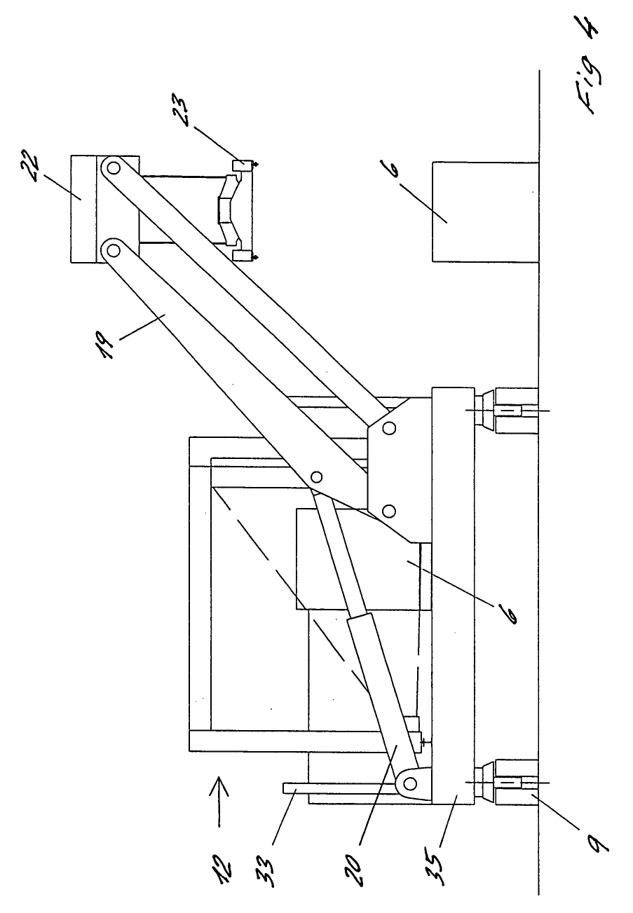

FIG. 4: Multifunctional platform without supports and with a pivot crane in a side view.

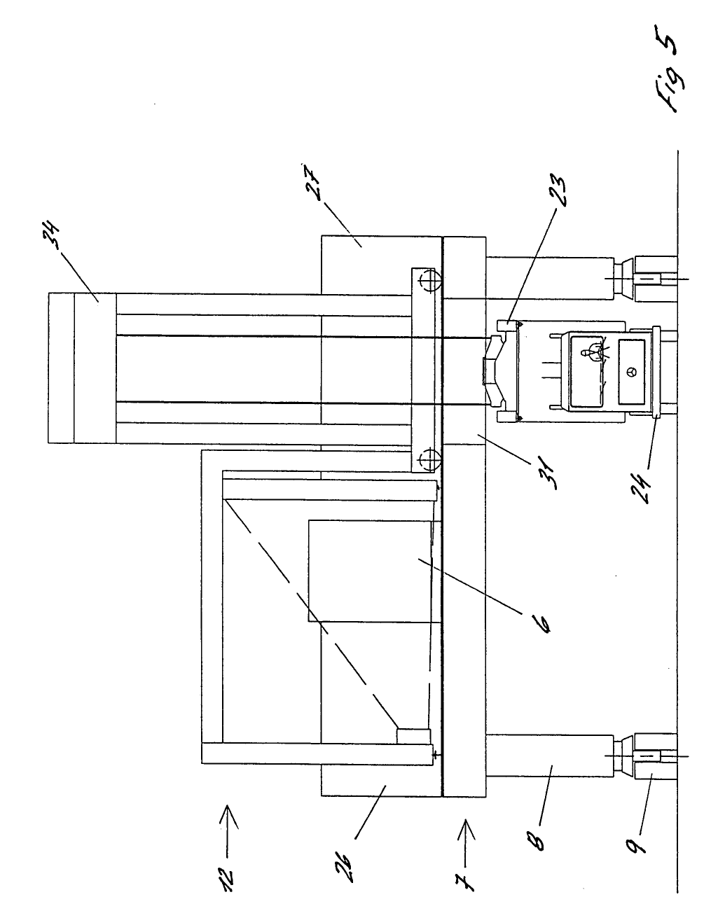

FIG. 5: Multifunctional platform with portal crane and an opening for passing containers through above a vehicle.

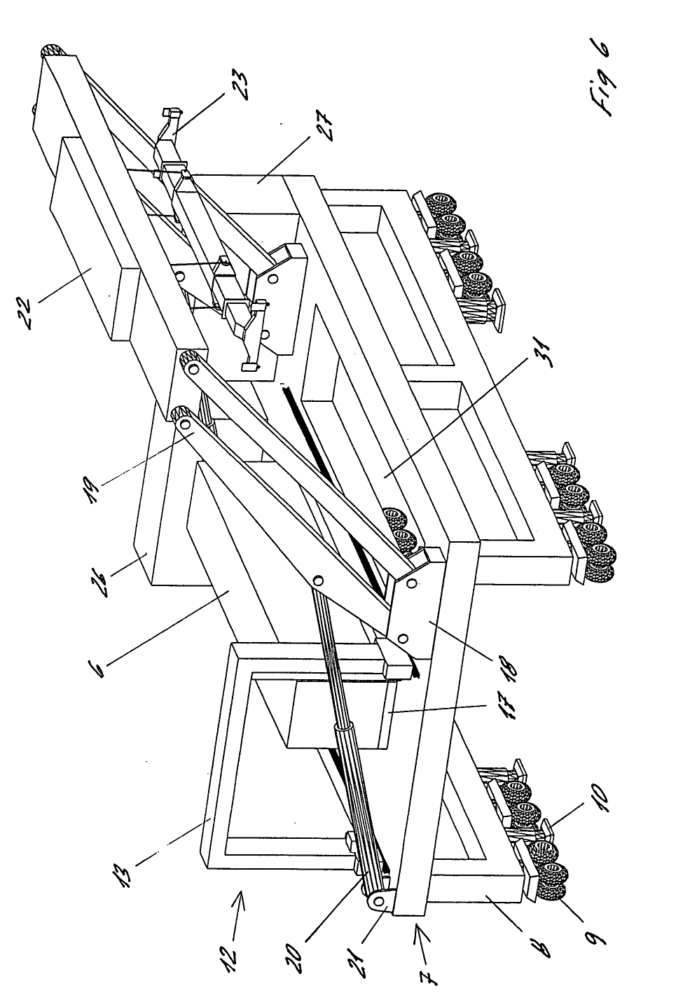

FIG. 6: Multifunctional platform in a perspective view.

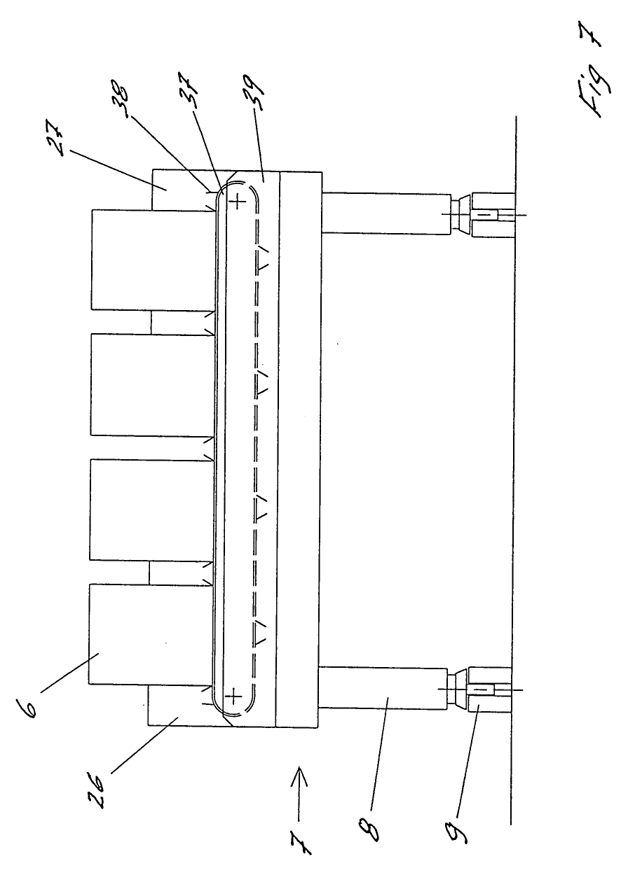

FIG. 7: Multifunctional platform with a horizontal conveyor belt.

FIG. 1 shows a container bridge 3 with trolley 4 and spreader 5 unloading containers 6 from a ship 1 at the pier 2. Under the container bridge 3, there is the mobile platform 7, the working height 29 of which is less than the height of the crossbeam 30 of the container bridge 3.

As FIG. 2 shows, the platform 7 has supports 8, so that its clear height 36 is sufficient to pass over the container transport vehicles 24. Next to driving wheels 9, which serve for displacement of the platform 7, props 10 are provided for stabilization. These props 10 can be used next to the wheels 9, or alternately with the driving wheels 9. A pivot crane 19 with traverse 22 and spreader 23 is disposed on the platform 7, which crane is used to remove containers 6 from the container transport vehicles 24 that are standing ready. The arms of the pivot crane 19 are mounted in a bearing 18 and are pivoted by means of hydraulic cylinders 20 that are connected with the bearing 21. The container 6, which is set onto a set-down platform 17 on the platform 7, is passed over by a transillumination device 12, in which a portal frame 13 is disposed on a guide rail 11, whereby a radiation source 14 and a radiation detector 15 passes over the container 6 in front of a shielding 16, so that the container is transilluminated. The result of the transillumination that is obtained is passed on to an operating location 27, at which a decision is made as to the location to which the container 6 is to be transported further.

FIG. 3 shows a top view of the platform 7 with container 6, which is standing ready for transillumination. The transillumination system 12 with its portal frame 13 moves on the travel rail 11 from one end of the container 6 to the other, so that an inspection can take place. The traverse 22 with lifting mechanism, the hydraulic cylinder 20, the pivot arm 19, and the bearing block 21 for the hydraulic cylinder 20 are disposed on both sides of the container 6 and the loading opening 31. The loading opening 31 serves to lower containers 6 to transport vehicles 24 that are standing ready. A technical room 26, an ascent 32, and a control room 27 are disposed on the right side of the device.

FIG. 4 shows a low platform 35, on which driving wheels 9 and props 10 are disposed. The construction of this platform 35 is essentially the same as that of a platform that stands higher. However, a shielding 33 is disposed on both sides of the transillumination device 12, in order to protect people.

FIG. 5 shows a portal crane 34 unloading a transport vehicle 24. The portal crane 34 can be displaced in both directions, on the platform 7. With its spreader 23, it seizes the container 6 of the transport vehicle 24 and sets it down onto the platform 7, in the working area of the transillumination device 12. A technical room 26 is disposed behind the transillumination device 12. The control frame 27 of the platform 7 is also disposed at the same height.

FIG. 6 shows the mobile multifunctional platform in a perspective view, whereby a container 6 was set down in the working area of the transillumination device 12, and the technical room 26 and the control room 27 is disposed on the platform 7. The loading opening 31, on both sides of which the bearing blocks 18 of the pivot crane 19 are disposed, allows unloading of the transport vehicles 24 that are parked underneath it. A traverse 22 is disposed on the two arms of the pivot crane 19, on which a spreader 23 serves to grasp the container 6 and can be moved up and down. The hydraulic cylinders 20 between bearing blocks 21 and the pivot crane 19 serve to move the pivot crane 19. The platform 7 has several supports 8, below which driving wheels 9 and props 10 are disposed.

FIG. 7 shows a high platform 7, on which supports 8, driving wheels 9, and props 10 are disposed. A horizontal conveyor belt 37 having container introduction corners 38 and a belt set-down construction 39 are constructed on the platform 7.

### List of Reference Symbols Used

1. container ship
2. pier
3. container bridge
4. container bridge, container trolley
5. spreader
6. container
7. high platform
8. supports of the platform
9. driving wheels
10. prop
11. guide rail
12. transillumination device
13. portal frame
14. radiation source
15. radiation detector
16. shielding
17. container set-down platform
18. bearing block—pivot crane
19. pivot crane
20. hydraulic cylinder
21. bearing block—hydraulic cylinder
22. traverse with lifting mechanism
23. spreader
24. transport vehicle, truck
25. transport vehicle, straddle carrier
26. technical room
27. control room
28. clear height of the crossbeam 3
29. working height of the platform
30. crossbeam of the container bridge 3
31. loading opening
32. ascent
33. platform shielding
34. portal crane
35. low platform
36. clear height of the platform
37. conveyor belt
38. container introduction corners
39. belt set-down construction

1. Mobile multifunctional platform for the transport and contact-free load inspection of containers, preferably of containers that are loaded using container bridges, comprising a
crane device on the side or on top of the platform (7, 35), for changing the position of containers (6),
platform (7, 35) for setting down and transilluminating containers (6),
transillumination device (12, 14, 15) on the platform (7, 35),
shielding (16, 33) that can be moved above and along the container (6),
displacement possibility (9) for the platform (7, 35).

2. Mobile platform according to claim 1, wherein supports (8), and, if necessary, props (10) are disposed between platform (7, 35) and traveling mechanism (9).

3. Mobile platform according to claim 1, wherein the clear height (28) below the platform (7) is higher than the container transport vehicles (24) to be passed over.

4. Mobile platform according to claim 1, wherein the working height (29) of the platform (7) is less than the height of the crossbeam (30) of the container bridge (3) to be passed under.

5. Mobile platform according to claim 1, wherein the crane device represents a pivot frame (19) with hydraulic cylinders (20) and integrated lifting mechanism with spreader (23).

6. Mobile platform according to claim 1, wherein the crane device represents a portal crane (34) on the platform (7).

7. Mobile platform according to claim 1, wherein the mobile platform (7) has an opening (31) for passing containers (6) through.

8. Mobile platform according to claim 1, wherein sensors for collision monitoring/positioning are disposed on the mobile platform (7) and the container bridge (3) and the mobile platform (7) are coupled with one another in terms of control technology.

9. Mobile platform according to claim 1, wherein a conveyor belt (37) for horizontal container transport is disposed on the platform (7).

10. Mobile platform according to claim 1, wherein rail-guided wheels are disposed as the displacement possibility 9.
